(19) United States
(12) Patent Application Publication
(10) Pub. No.: US 2022/0144187 A1
(43) Pub. Date: May 12, 2022

(54) CAMERA SYSTEM FOR A TRAILER HITCH SYSTEM

(71) Applicant: Robert Bosch GmbH, Stuttgart (DE)

(72) Inventors: Christian Sperrle, Ann Arbor, MI (US); Phanikumar K. Bhamidipati, Novi, MI (US); Matthew J. Barton, Hermantown, MN (US); Ammar Jamal Eddin, Dearborn Heights, MI (US); Niara Simpson, Bethlehem, PA (US)

(21) Appl. No.: 17/521,394

(22) Filed: Nov. 8, 2021

Related U.S. Application Data
(60) Provisional application No. 63/110,755, filed on Nov. 6, 2020.

(51) Int. Cl. B60R 11/04; B60R 1/00; G06K 9/00; B60W 50/14; B60W 30/09

(52) U.S. Cl. CPC B60R 11/04; B60R 1/00; G06K 9/00805; B60W 50/14; B60W 2050/146; B60R 2300/105; B60R 2300/102; B60R 2300/802; B60W 2420/42; B60W 30/09

(57) ABSTRACT

A trailer-camera system for a vehicle coupled to a trailer. The system includes a first plurality of cameras configured to capture a video image including a region of interest surrounding the trailer, a second plurality of cameras configured to capture a video image including a region of interest surrounding the vehicle, and an electronic processor. The processor is configured to receive images from the first and second plurality of cameras and determine a trailer angle. The processor is further configured to generate a first 360-degree image view of an area surrounding the trailer based on an image stitching of the first plurality of images, generate a second 360-degree image view of an area surrounding the vehicle based on an image stitching of the second plurality of images, and generate a combined 360-degree image view from the first and second views based on the trailer angle.

### CROSS-REFERENCE TO RELATED APPLICATION

The present application claims priority to U.S. Provisional Patent Application No. 63/110,755, filed Nov. 6, 2020, the entire content of which is incorporated herein by reference.

### FIELD

Embodiments relate to automotive camera systems.

### BACKGROUND

Vehicles, such as automobiles, trucks, SUVs, vans, recreational vehicles, etc., may be equipped with a multiple camera system, sometimes known as a near-range camera system that can be used to provide a 360 degree view (in 2D or 3D) of the car itself (a top down or “birds-eye view”). When the vehicle is coupled to a trailer, a view from one or more of the cameras of the near-range camera system may be obstructed, which may affect the generated 360-degree view. Additionally, the 360-degree view will not include the trailer, limiting a user's ability to view objects surrounding the trailer.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a trailer camera system, according to some embodiments.

FIG. 2A is a block diagram of a camera system of the vehicle of the trailer camera system of FIG. 1, according to some embodiments.

FIG. 2B is a block diagram of a camera system of the trailer of the trailer camera system of FIG. 1, according to some embodiments.

FIG. 3 is a block diagram of an electronic controller of the trailer camera system of FIG. 1, according to some embodiments.

FIG. 4 is a flow chart of method for generating a 360-degree image view of a vehicle coupled to a trailer of the system of FIG. 1, according to some embodiments.

FIG. 5 is a diagram illustrating the generated views from video images captured by the cameras of the system of FIG. 1.

FIG. 6 is an example 360-degree image view generated by the system of FIG. 1, according to some embodiments.

FIG. 7 is a table illustrating a plurality of generated views from video images captured by the cameras of the system of FIG. 1, according to some embodiments.

FIG. 8A is an example of a modified combined 360-degree image view, according to some embodiments.

FIG. 8B is an example of a modified combined 360-degree image view, according to some embodiments.

FIG. 8C is an example of a modified combined 360-degree image view, according to some embodiments.

FIG. 9 is an example of a modified combined 360-degree image view, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### SUMMARY

The present specification relates generally to the field of rear camera systems for vehicles. Vehicles, such as automobiles, trucks, SUVs, vans, recreational vehicles, etc., may be equipped with a rear camera system, sometimes known as a backup camera or reversing camera. The rear camera is configured to capture an image of the area behind the vehicle, generally the area towards the ground. The area may include a blind spot hidden from view of the rear-view mirror and side view mirrors. The image is transferred to a display, allowing the driver to monitor the area behind the vehicle.

### DETAILED DESCRIPTION

Before any embodiments are explained in detail, it is to be understood that the examples presented herein are not limited in their application to the details of construction and the arrangement of components set forth in the following description or illustrated in the following drawings. Embodiments may be practiced or carried out in various ways.

It should also be noted that a plurality of hardware and software-based devices, as well as a plurality of different structural components may be used to implement the embodiments presented herein. In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects may be implemented in software (for example, stored on non-transitory computer-readable medium) executable by one or more processors. As such, it should be noted that a plurality of hardware and software-based devices, as well as a plurality of different structural components may be utilized to implement the embodiments presented. For example, “control units” and “controllers” described in the specification can include one or more electronic processors, one or more memory modules including non-transitory computer-readable medium, one or more input/output interfaces, and various connections (for example, a system bus) connecting the components.

For ease of description, each of the example systems presented herein is illustrated with a single exemplar of each of its component parts. Some examples may not describe or illustrate all components of the systems. Other embodiments may include more or fewer of each of the illustrated components, may combine some components, or may include additional or alternative components.

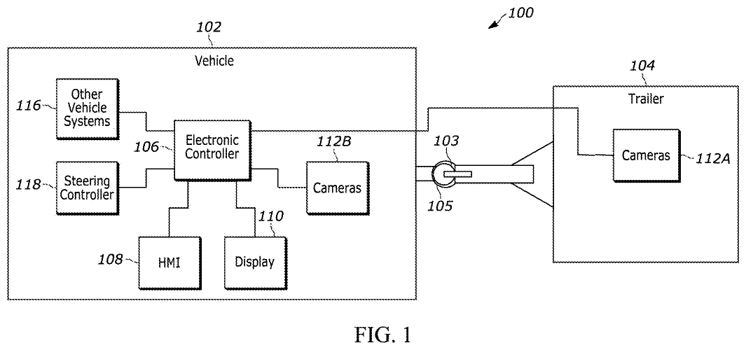

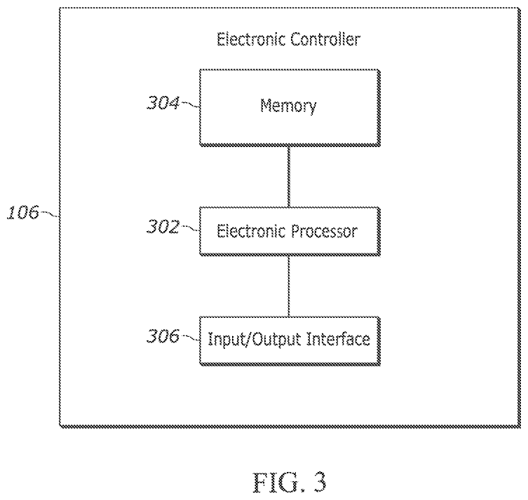

FIG. 1 is a block diagram of one example embodiment of a trailer camera system 100. The trailer camera system 100 is integrated into a vehicle 102 and a trailer 104. The vehicle 102 is equipped with a trailer hitch 103, positioned at the rear of the vehicle 102. The trailer 104 has a trailer coupling (or coupler) 105 positioned at the front of the trailer 104. The trailer hitch 103 may one of numerous kinds of hitches (for example, a ball type trailer hitch having a ball) or, for example, a hitch that is received by a recess of the trailer coupler 105 to connect (or hitch) the trailer 104 to the vehicle 102. The trailer 104 may one of numerous types of vehicle trailers (for example, an enclosed trailer, vehicle hauling trailer, recreational vehicle (RV) trailer, and the like). While the trailer 104 is described below (in particular, regarding the method 300 in FIG. 3) as being an enclosed trailer, this should not be considered limiting. The systems and methods described herein are applicable to other types of trailers.

The trailer camera system 100 includes an electronic controller 106, a human machine interface (HMI) 108, a display 110, a first plurality of cameras 112A positioned on the trailer 104, a second plurality of cameras 112B positioned on the vehicle 112B, and other vehicle systems 116. The electronic controller 106, the HMI 108, the display 110, the plurality of cameras 112A and 112B, and the other vehicle systems 116, as well as other various modules and components of the vehicle 102 are communicatively coupled to each other via wired connections, wireless connections, or some combination thereof. All or parts of the connections used in the system 100 may be implemented using various communication networks, for example, a Bluetooth™ network, a control area network (CAN) , a wireless local area network (for example, Wi-Fi), a wireless accessory Personal Area Networks (PAN), and the like. The use of communication networks for the interconnection between and exchange of information among the various modules and components would be apparent to a person skilled in the art in view of the description provided herein.

In some embodiments, the electronic controller 106 includes a plurality of electrical and electronic components that provide power, operational control, and protection to the components and modules within the electronic controller 106. As shown in FIG. 3, the electronic controller 106 includes, among other things, an electronic processor 202 (for example, an electronic microprocessor, microcontroller, or other suitable programmable device), a memory 206, and an input/output interface 208. The electronic processor 202, the memory 204, and the input/output interface 206, as well as the other various modules are connected by one or more control or data buses. In some embodiments, the electronic controller 106 is implemented partially or entirely in hardware (for example, using a field-programmable gate array (“FPGA”), an application specific integrated circuit (“ASIC”), or other devices.

The electronic processor 202 obtains and provides information (for example, from the memory 204 and/or the input/output interface 206), and processes the information by executing one or more software instructions or modules, capable of being stored, for example, in a random access memory (“RAM”) area of the memory 204 or a read only memory (“ROM”) of the memory 204 or another non-transitory computer readable medium (not shown). The software can include firmware, one or more applications, program data, filters, rules, one or more program modules, and other executable instructions.

The memory 204 can include one or more non-transitory computer-readable media and includes a program storage area and a data storage area. As used in the present application, “non-transitory computer-readable media” comprises all computer-readable media but does not consist of a transitory, propagating signal. The program storage area and the data storage area can include combinations of different types of memory, for example, read-only memory (“ROM”), random access memory (“RAM”), electrically erasable programmable read-only memory (“EEPROM”), flash memory, or other suitable digital memory devices. The electronic processor 202 is connected to the memory 204 and executes software, including firmware, one or more applications, program data, filters, rules, one or more program modules, and other executable instructions. The electronic processor 202 retrieves from the memory 204 and executes, among other things, instructions related to the control processes and methods described herein.

The input/output interface 206 is configured to receive input and to provide system output. The input/output interface 206 obtains information and signals from, and provides information and signals to (for example, over one or more wired and/or wireless connections) devices and/or components both internal and external to the system 100.

In some embodiments, the electronic controller 106 may include additional, fewer, or different components. For example, in some embodiments, the controller electronic 106 may include a transceiver or separate transmitting and receiving components, for example, a transmitter and a receiver. Some or all of the components of electronic controller 106 may be dispersed and/or integrated into other devices/components of the system 100 (for example, a vehicle control module or VCM, not shown, of the vehicle 102).

Returning to FIG. 1, each of the plurality of cameras 112A and 112B of the system 100 are video cameras, positioned to capture video images of an area surrounding the trailer 104 and the vehicle 102 respectively. In some embodiments one or more of the cameras 112A and 112B are moveable (for example, using pan, tilt, or zoom functions) to capture video images of other areas on or around the trailer 104 and/or vehicle 102. In some embodiments, one or more of the plurality of cameras 112A and 112B may be part of a back-up video camera system of the vehicle 102. Backup video cameras are known and will not be described in further detail.

FIG. 3A is a block diagram 300A of the plurality of cameras 112B of the vehicle 102. As illustrated in FIG. 3A, each of the cameras of the plurality of cameras 112B is positioned at a respective portion of the vehicle 102 to capture video images of a respective area surrounding the vehicle 102. The field of view (image capture) of one or more of the plurality of cameras 112B may overlap with a field of view of another camera of the plurality 112B. The fields of view of each of the cameras of the plurality of cameras 112B collectively capture image data of the complete area surrounding the vehicle 102. As explained below in more detail, the electronic controller 106 is configured to image stitch the images captured by the plurality of cameras 112B together to generate a 360 degree (“bird's eye”) view of the vehicle 102 and the area surrounding the vehicle 102.

The plurality of cameras 112A of the trailer 104 are similarly positioned at respective portions of the trailer 104 to capture the complete area surrounding the trailer 104. The field of view (image capture) of one or more of the plurality of cameras 112A may overlap with a field of view of another camera of the plurality 112A. FIG. 3B is a diagram 300B illustrating an example positioning of the plurality of cameras 112A on the trailer 104. As also explained below in more detail, the electronic controller 106 is configured to image stitch the images captured by the plurality of cameras 112A together to generate a 360 degree (“bird's eye”) view of the trailer 104 and the area surrounding the trailer 104.

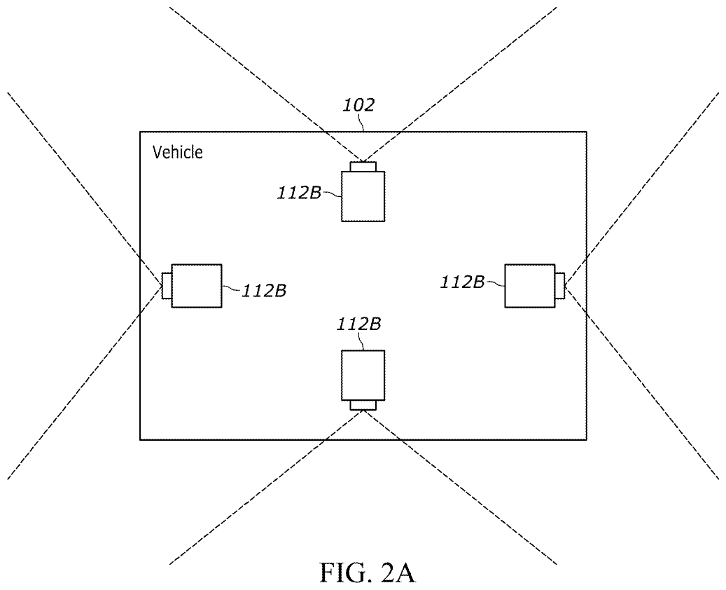

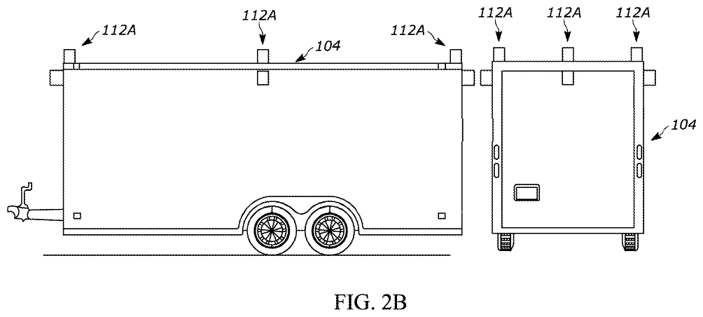

It should be understood that, while only a select number of cameras 112A and 112B are illustrated in FIGS. 2B and 2A respectively, each of the plurality of cameras 112A and 112B may include additional or fewer cameras than illustrated.

The HMI 108 provides an interface between the vehicle 102 and the driver. The HMI 108 is communicatively coupled to the electronic controller 106 and receives input from the driver, receives information from the electronic controller 106, and provides feedback (for example, audio, visual, haptic, or a combination thereof) to the driver based on the received information. The HMI 108 provides suitable input mechanisms, for example, a button, a touch-screen display having menu options, voice recognition, and the like for providing inputs from the driver that may be used by the electronic controller 106 as it controls the vehicle 102.

The HMI 108 provides visual output, for example, a graphic user interface having graphical elements or indicators (for example, fixed or animated icons), lights, colors, text, images (for example, from the camera 108), combinations of the foregoing, and the like. The HMI 108 includes a suitable display device, for example the display 110, for displaying the visual output, for example, an instrument cluster, a mirror, a heads-up display, a center console display screen (for example, a liquid crystal display (LCD) touch screen, or an organic light-emitting diode (OLED) touch screen), or through other suitable devices. In some embodiments, the HMI 108 includes a graphical user interface (GUI) (for example, generated by the electronic controller 106, from instructions and data stored in the memory, and presented on a center console display screen) that enables a user to interact with the system 100. The HMI 108 may also provide audio output to the driver, for example, a chime, buzzer, voice output, or other suitable sound through a speaker included in the HMI 108 or separate from the HMI 108. In some embodiments, the HMI 108 includes components configured to provide haptic outputs to the driver, for example, to vibrate one or more vehicle components (for example, the vehicle's steering wheel and the driver's seat), for example, through the use of a vibration motor. In some embodiments, HMI 108 provides a combination of visual, audio, and haptic outputs. In some embodiments, the HMI 108 causes the visual, audio, and haptic outputs to be produced by a smart phone, a smart tablet, a smart watch, or other portable or wearable electronic device communicatively coupled to the vehicle 102.

The other vehicle systems 116 include controllers, sensors, actuators, and the like for controlling aspects of the operation of the vehicle 102 (for example, acceleration, braking, shifting gears, and the like). The other vehicle systems 116 are configured to send and receive data relating to the operation of the vehicle 102 to and from the electronic controller 106. For example, in some embodiments, the system 100 may include a steering controller 118 coupled to a steering system (not shown) of the vehicle 102. The steering controller 118 may be configured to automatically steer the vehicle 102 in response to commands received from, among other things, the electronic controller 106. The steering controller 118 may also receive steering commands from a steering wheel of the vehicle 102 (for example, in a “drive by wire” system). In some embodiments, the electronic processor 106 is configured to perform a parking and/or reverse assist function to guide (visually or automatically via the steering controller 118) the vehicle 102 (with or without the trailer 104) into a user-desired area surrounding the vehicle 102 to park.

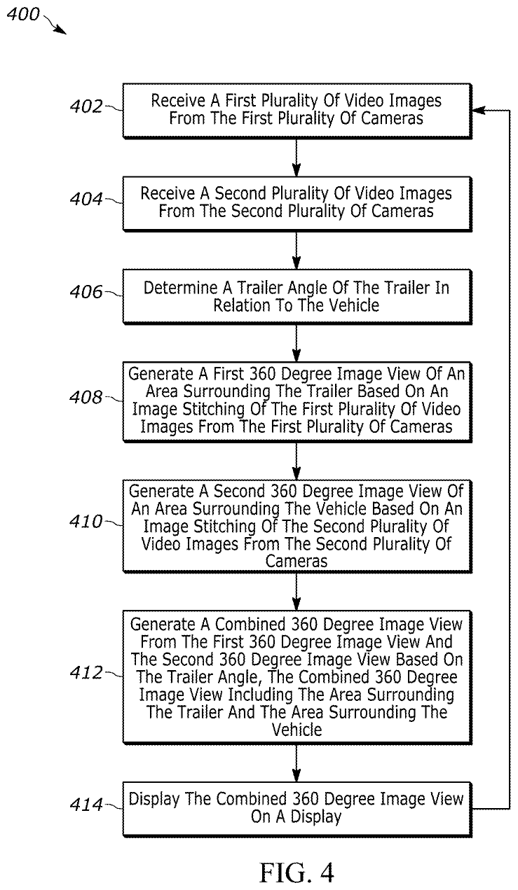

FIG. 4 illustrates an exemplary method 300 for generating a 360-degree image view display of vehicle 102 coupled to the trailer 104. As an example, the method 300 is explained in terms of the electronic controller 106, in particular the electronic processor 202. However, it should be understood that portions of the method 400 may be distributed among multiple devices (for example, one or more additional controllers/processors of the system 100).

At block 402, the electronic processor 202 receives a first plurality of video images from the plurality of cameras 112A positioned on the trailer 104 and, at block 404, receives a second plurality of video images from the plurality of cameras 112B positioned on the vehicle 102. At block 406, the electronic processor 202 determines a trailer angle of the trailer 104 in relation to the vehicle 102 (for example, via an image analysis of one or more images from one or more of the cameras 112A and 112B or a trailer angle sensor, which is not shown, within the trailer hitch 103).

At block 408, the electronic processor 202 generates a first 360-degree image view of an area surrounding the trailer 104 based on an image stitching of the first plurality of video images from the first plurality of cameras 112A and, at block 410, generates a second 360-degree image view of an area surrounding the vehicle 102 based on an image stitching of the second plurality of video images from the second plurality of cameras 112B.

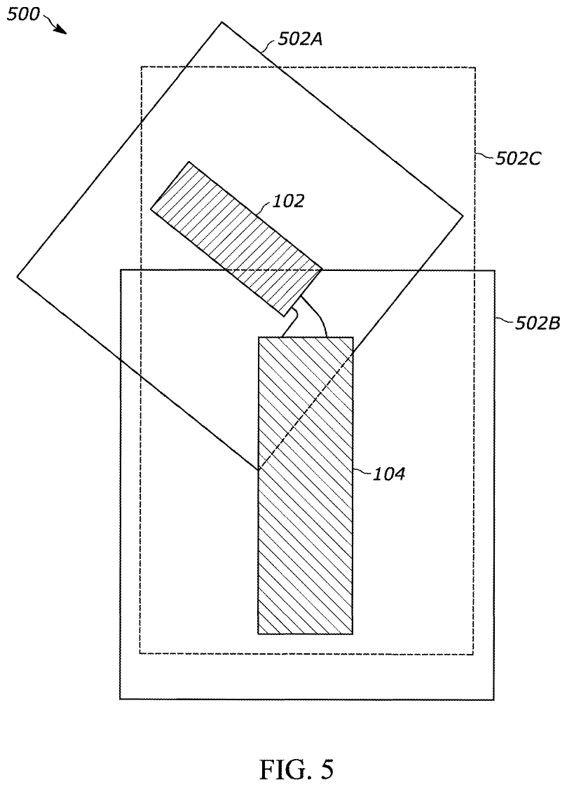

At block 412, the electronic processor 202 generates a combined 360-degree image view from the first 360-degree image view and the second 360-degree image view based on the trailer angle and, at block 414, displays the combined 360-degree image view on a display (for example, the display 110). The combined 360-degree image view includes both the area surrounding the trailer and the area surrounding the vehicle. The combined 360-degree image view is, in some embodiments, a blend/image stitching of the first and second 360-degree image views. The first and second 360-degree image views are combined via a blended/stitching algorithm such that the resulting combined 360-degree image view is a top down view of the vehicle 102 coupled to the trailer 104 and the area surrounding both. FIG. 5 illustrates a diagram 500 including the vehicle 102 and the trailer 104. Boxes 502A and 502B indicate the 360-degree view of the area surrounding the vehicle 102 and the trailer 104 (504A and 504B respectively). Box 504C indicates the resulting viewable resolution of the combined 360-degree image view. FIG. 6 is an example of a resulting combined 360-degree image view 600.

In some embodiments, the electronic processor 202 is configured to generate the combined 360-degree image view based on additional factors. For example, in some embodiments, the electronic processor 202 generates the combined 360-degree image view based on a position (x, y, z, pitch, roll, yaw) of one or more of the first plurality of cameras 112A in relation to a position of one or more of the second plurality of cameras 112B so both the 360-degree image views of the trailer 104 and the vehicle 102, when stitched together, visually appear to have been captured from approximately the same point of view (for example, scaled, zoomed, cropped, panned, skewed, and the like).

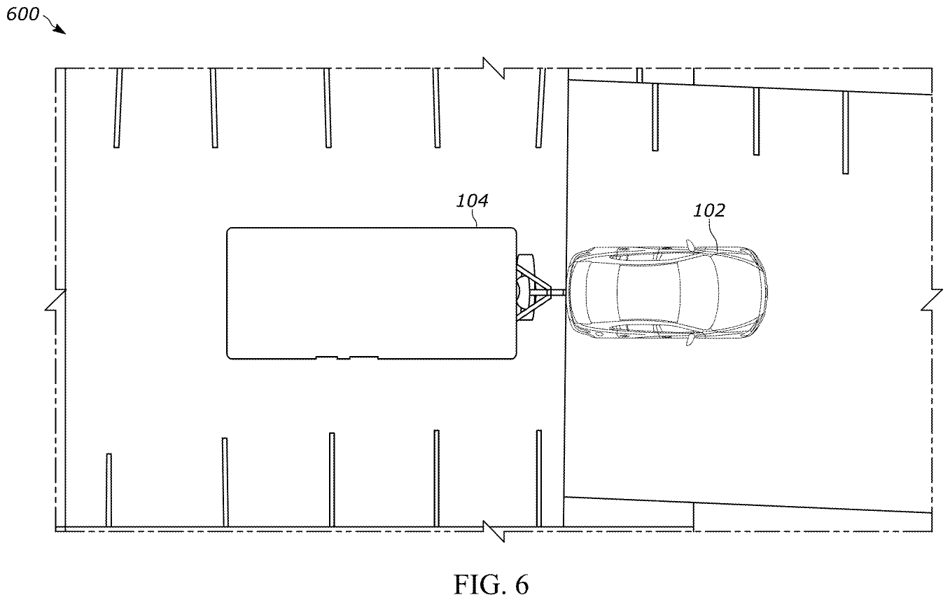

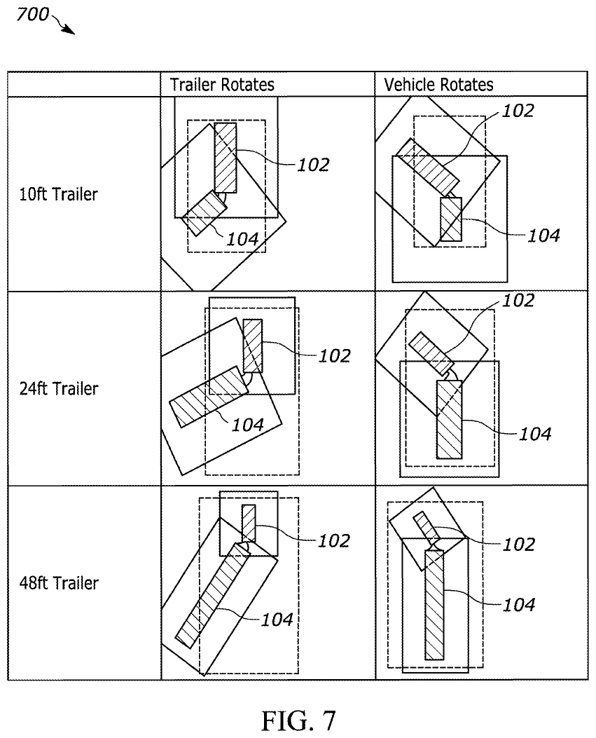

In some embodiments, the electronic processor 202 is configured to modify the combined 360-degree image view based on the whether the vehicle 102 is turning (for example, turning onto a road or changing lanes on a road). The electronic processor 202 may determine that the vehicle is turning based on a steering angle of the steering wheel (determined for example, via a steering wheel angle sensor, not shown). In some embodiments, the electronic processor 202 determines that the vehicle 102 is turning, or going to turn, based on information from a route planning/navigation assistance system being used by a driver of the vehicle 102. FIG. 7 is a table 600 illustrating how a resulting rotation (during turning) of the vehicle 102 or the trailer 104 (as well as a length of the trailer 104) affects a viewable resolution area of the combined 360-degree image view. As illustrated, both factors may leave areas of missing image information as the rotating vehicle 102 or trailer 104 (and their respective cameras 112B and 112A) move out of the resolution box. The electronic processor 202 may be configured to fill in (via augmentation) the areas of missing image information to increase the size of the total viewable resolution box. The electronic processor 202 may then generate pan, zoom, and/or scale a desired area of the viewable resolution area to display on the display 110 as shown in the modified combined 360-degree image views in FIG. 7.

Modification of the combined 360-degree image view may also be based on one or more dimensions (for example, width or height) of the trailer 104. The electronic processor 202 may determine the dimension information of the trailer 104, for example, directly from a user input (for example, via HMI 108) or automatically calculated via video analysis from images from one or more of the cameras 112A and 112B. The electronic processor 202 may also modify the combined 360-degree image view based on a user input (for example, received via HMI 108).

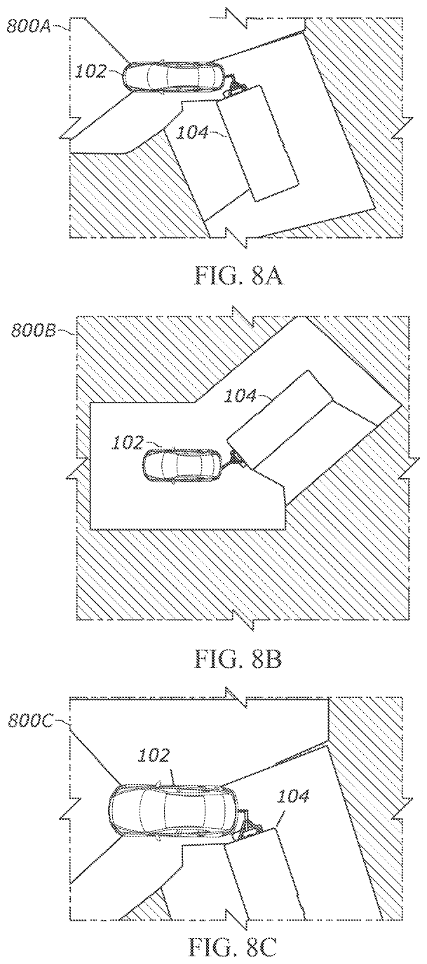

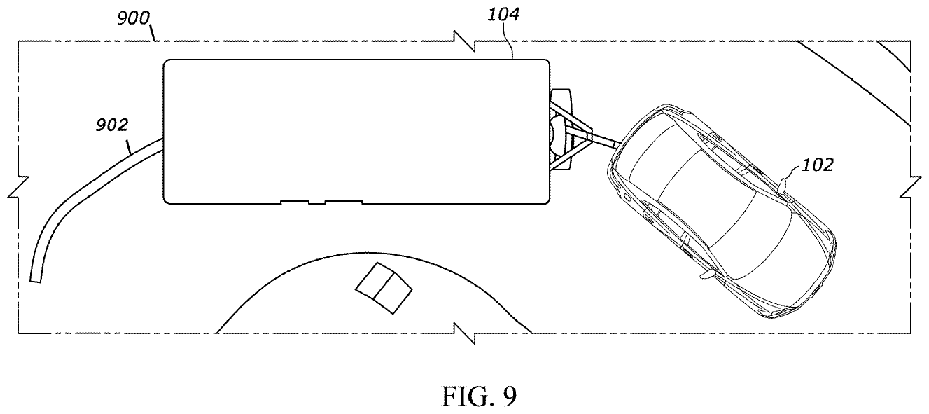

In some embodiments, the combined 360-degree image view includes one or more augmented indications or items. For example, in some embodiments, the electronic processor 202 is configured to augment an indication of one or more dimensions of the trailer 104 into the combined 360-degree image view. In some embodiments, the electronic processor 202 is configured to determine a predicted trajectory based on the trailer angle of the trailer 104 (or, in embodiments where the vehicle 102 includes a trailer back-up assist system, a desired trajectory) of the trailer 104 and augment the combined 360-degree image view to include an indication of the predicted and/or desired trajectory. Example combined views 800A-800C are shown in FIGS. 8A-8C respectively. In some embodiments, the combined 360-degree image view may be utilized by the electronic processor 202 as part of a trailer back-up assist program. For example, when displayed on the display, a user may touch and drag the indication of the desired trajectory (for example, trajectory line 902 in the combined view 900 of FIG. 9) to modify the desired trajectory and the processor 302 may update the trailer back-up assist program accordingly. In further embodiments, the electronic processor 302 is configured to identify one or more objects within the combined 360-degree image view and augment the combined 360-degree image view to highlight the object. The object may be a stationary or moving object (for example a pedestrian, a bicycle, a vehicle, and the like). In some embodiments, the electronic processor 202 is configured to detect an object (within or outside the region within the combined 360-degree image view) that may intersect with a predicted/desired trajectory of the trailer 104 and, in response, provide augment a visual indication of the object within the combined 360-degree image view. An object not within the combined 360-degree image view may be detected by the electronic processor 202 if the object is within a field of view of the one or more cameras 112A and 112B of the system 100. In further embodiments, the electronic processor 202 is configured to predict a trajectory of an object (for example, if the object is a moving object) within or outside of the region within the combined 360-degree image view and determines if a collision with the trailer 104 and the moving object may occur (for example, based on a predicted trajectory of the trailer 104 and/or a distance of the object's predicted trajectory to the trailer 104). The electronic processor 202 may then augment a visual indication into the combined 360-degree image view to alert the driver of the possible collision. The electronic processor 202 may additionally provide one or more indications (for example, an audible or haptic alert) to the user of the vehicle 102 to notify the user of a detected object and/or possible collision. In some embodiments, the electronic processor 202 may be configured to, following an initial indication of a possible collision, automatically control the vehicle 102 so as to avoid the possible collision (for example, automatically brake the vehicle 102).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

Thus, embodiments provide, among other things, a trailer hitch guidance system including a human machine interface. Various features and advantages of the invention are set forth in the following claims.

What is claimed is:

1. A trailer-camera system for a vehicle coupled to a trailer, the system comprising:
a first plurality of cameras, each positioned on the trailer and configured to capture a video image including a region of interest surrounding the trailer;
a second plurality of cameras, each positioned on the vehicle and configured to capture a video image including a region of interest surrounding the vehicle;
an electronic processor configured to:
receive a first plurality of video images from the first plurality of cameras;
receive a second plurality of video images from the second plurality of cameras;
determine a trailer angle of the trailer in relation to the vehicle;
generate a first 360-degree image view of an area surrounding the trailer based on an image stitching of the first plurality of video images from the first plurality of cameras;
generate a second 360-degree image view of an area surrounding the vehicle based on an image stitching of the second plurality of video images from the second plurality of cameras;
generate a combined 360-degree image view from the first 360-degree image view and the second 360-degree image view based on the trailer angle, the combined 360-degree image view including the area surrounding the trailer and the area surrounding the vehicle; and
display the combined 360-degree image view on a display.

2. The trailer-camera system of claim 1, wherein the electronic processor is configured to modify the combined 360-degree image view based on whether the vehicle is in a reverse gear or is turning.

3. The trailer-camera system of claim 1, wherein the electronic processor generates the combined 360-degree image view based on a position of one or more of the first plurality of cameras in relation to a position of one or more of the second plurality of cameras.

4. The trailer-camera system of claim 1, wherein the electronic processor generates the combined 360-degree image view based on a dimension of the trailer.

5. The trailer-camera system of claim 1, wherein the electronic processor is further configured to identify an object within the combined 360-degree image view and augment the combined 360-degree image view to highlight the object.

6. The trailer-camera system of claim 1, wherein the electronic processor is further configured to determine a predicted trajectory of the trailer based on the trailer angle of the vehicle and augment the combined 360-degree image view to include an indication of the predicted trailer trajectory.

7. The trailer-camera system of claim 1, wherein the electronic processor is further configured to augment the combined 360-degree image view to include an indication of a dimension of the trailer.

8. A method for generating a 360-degree image view of a vehicle coupled to a trailer, the method comprising:
receiving a first plurality of video images from a first plurality of cameras each positioned on the trailer, each of the first plurality of video images including a region of interest surrounding the trailer;
receiving a second plurality of video images from a second plurality of cameras each positioned on the vehicle, each of the second plurality of video images including a region of interest surrounding the vehicle;
determining a trailer angle of the trailer in relation to the vehicle;
generating a first 360-degree image view of an area surrounding the trailer based on an image stitching of the first plurality of video images from the first plurality of cameras;
generating a second 360-degree image view of an area surrounding the vehicle based on an image stitching of the second plurality of video images from the second plurality of cameras;
generating a combined 360-degree image view from the first 360-degree image view and the second 360-degree image view based on the trailer angle, the combined 360-degree image view including the area surrounding the trailer and the area surrounding the vehicle; and
displaying the combined 360-degree image view on a display.

9. The method of claim 8, the method further comprising modifying the combined 360-degree image view based on whether the vehicle is in a reverse gear or is turning.

10. The method of claim 8, wherein the combined 360-degree image view is generated based on a position of one or more of the first plurality of cameras in relation to a position of one or more of the second plurality of cameras.

11. The method of claim 8, wherein the combined 360-degree image view is generated based on a dimension of the trailer.

12. The method of claim 8, the method further comprising identifying an object within the combined 360-degree image view and augmenting the combined 360-degree image view to highlight the object.

13. The method of claim 8, the method further comprising determining a predicted trajectory of the trailer based on the trailer angle of the vehicle and augmenting the combined 360-degree image view to include an indication of the predicted trailer trajectory.

14. The method of claim 8, the method further comprising augmenting the combined 360-degree image view to include an indication of a dimension of the trailer.
